(19) United States
(12) Patent Application Publication
(10) Pub. No.: US 2024/0310706 A1
(43) Pub. Date: Sep. 19, 2024

(54) WAVELENGTH CONVERSION DEVICE, METHOD OF MANUFACTURING WAVELENGTH CONVERSION DEVICE, ILLUMINATION DEVICE, AND PROJECTOR

(71) Applicant: SEIKO EPSON CORPORATION, Tokyo (JP)

(72) Inventor: Toshiaki HASHIZUME, OKAYA-SHI (JP)

(21) Appl. No.: 18/605,316

(22) Filed: Mar. 14, 2024

(30) Foreign Application Priority Data
Mar. 17, 2023 (JP) 2023-042743

(51) Int. Cl. G03B 21/20

(52) U.S. Cl. CPC G03B 21/204; G03B 21/2066

(57) ABSTRACT

A wavelength conversion device includes a substrate, a wavelength conversion layer disposed on the substrate and including a plurality of phosphor particles and a bonding member configured to bond the phosphor particles and the substrate to each other, and a reflecting layer disposed between the substrate and the wavelength conversion layer and configured to reflect light. A particle size distribution of the phosphor particles is no smaller than 40 μm and no larger than 200 μm. A center value of the particle size distribution is no smaller than 70 μm and no larger than 150 μm. Some of the phosphor particles are thermally coupled to the reflecting layer. 50% or more of the phosphor particles are thermally coupled to each other. A thickness of the bonding member is no smaller than 30% and no larger than 80% of a thickness of the wavelength conversion layer.

The present application is based on, and claims priority from JP Application Serial Number 2023-042743, filed Mar. 17, 2023, the disclosure of which is hereby incorporated by reference herein in its entirety.

### BACKGROUND

### 1. Technical Field

The present disclosure relates to a wavelength conversion device, a method of manufacturing a wavelength conversion device, an illumination device, and a projector.

### 2. Related Art

In JP-A-2021-060470 (Document 1), there is disclosed a technology of raising a cross-sectional ratio of a phosphor particle group to a value no lower than 50% in a wavelength conversion member provided with a substrate, and a wavelength conversion layer including the phosphor particle group and a sealing member, and at the same time, raising a filling rate using both of phosphor particles large in particle size no smaller than 40 μm in cross-sectional surface, and phosphor particles small in particle size no larger than 30 μm in cross-sectional surface, to thereby raise the thermal conductivity of the wavelength conversion layer.

However, in the wavelength conversion member disclosed in Document 1, since the phosphor particle small in particle size no larger than 30 μm is large in specific surface area, there is a problem that the light intensity of fluorescence which can be taken out to the outside decreases since the fluorescence is reflected inside the wavelength conversion layer.

### SUMMARY

In view of the problems described above, according to an aspect of the present disclosure, there is provided a wavelength conversion device including a substrate, a wavelength conversion layer disposed on the substrate and including a plurality of phosphor particles and a bonding member configured to bond the plurality of phosphor particles and the substrate to each other, and a reflecting layer disposed between the substrate and the wavelength conversion layer and configured to reflect light emitted from the wavelength conversion layer, wherein particle sizes of the plurality of phosphor particles are no smaller than 40 μm and no larger than 200 μm, a center value of a particle size distribution of the plurality of phosphor particles is no smaller than 70 μm and no larger than 150 μm, some of the phosphor particles are thermally coupled to the reflecting layer, 50% or more of the phosphor particles are thermally coupled to each other, and a thickness of the bonding member is no smaller than 30% and no larger than 80% of a thickness of the wavelength conversion layer.

Further, according to another aspect of the present disclosure, there is provided a method of manufacturing a wavelength conversion device which includes a substrate, a wavelength conversion layer which is disposed on the substrate, and in which a plurality of phosphor particles and the substrate are bonded to each other with a bonding member, and a reflecting layer disposed between the substrate and the wavelength conversion layer and configured to reflect light emitted from the wavelength conversion layer. The phosphor particles has a particle size no smaller than 40 μm and no larger than 200 μm, and a center value of a particle size distribution no smaller than 70 μm and no larger than 150 μm. A thickness of the bonding member is no smaller than 30% and no larger than 80% of a thickness of the wavelength conversion layer. The method includes applying a coating film for the bonding member configured to form the bonding member on the reflecting layer disposed on the substrate, arranging a phosphor particle group including the plurality of phosphor particles to the coating film for the bonding member, pressing the phosphor particle group toward the reflecting layer with a pressing member, and calcining the coating film for the bonding member together with the substrate and the phosphor particle group to form the bonding member.

Further, according to another aspect of the present disclosure, there is provided an illumination device including a light source configured to emit excitation light, and the wavelength conversion device according to the aspect described above which the excitation light enters.

Further, according to another aspect of the present disclosure, there is provided a projector including the illumination device according to the aspect described above, a light modulation device configured to modulate light emitted from the illumination device, and a projection optical device configured to project the light modulated by the light modulation device.

### BRIEF DESCRIPTION OF THE DRAWINGS

FIG. 1 is a schematic configuration diagram showing a projector according to an embodiment.

FIG. 2 is a schematic configuration diagram showing an illumination device.

FIG. 3 is a cross-sectional view showing a configuration of a wavelength conversion device.

FIG. 4 is a graph representing a particle size distribution of phosphor particles.

FIG. 5 is a graph representing a relationship between the thickness of a bonding member and an amount of fluorescence emitted.

FIG. 6A is a diagram showing a manufacturing process of the wavelength conversion device.

FIG. 6B is a diagram showing the manufacturing process of the wavelength conversion device.

FIG. 6C is a diagram showing the manufacturing process of the wavelength conversion device.

FIG. 6D is a diagram showing the manufacturing process of the wavelength conversion device.

FIG. 6E is a diagram showing the manufacturing process of the wavelength conversion device.

### DESCRIPTION OF EMBODIMENTS

An embodiment of the present disclosure will hereinafter be described in detail with reference to the drawings. It should be noted that the drawings used in the following description show characteristic parts in an enlarged manner in some cases for the sake of convenience in order to make the features easy to understand, and the dimensional ratios between the components and so on are not necessarily the same as actual ones.

An embodiment of the present disclosure will hereinafter be described.

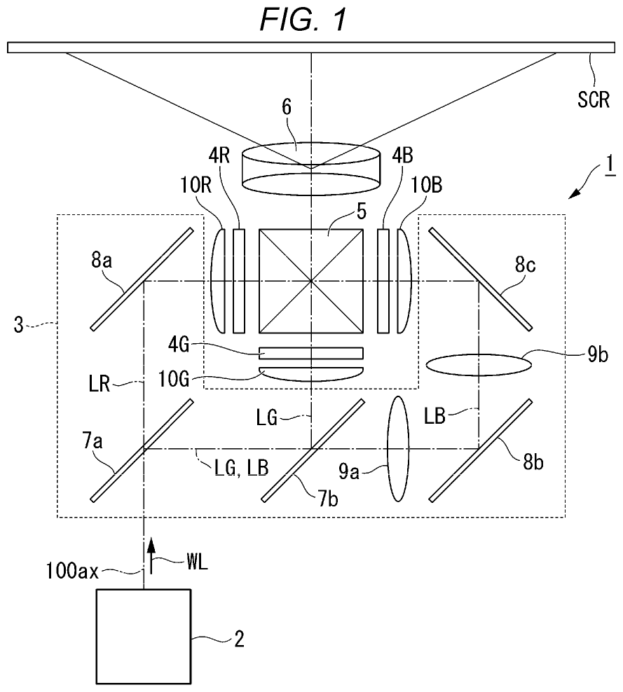

FIG. 1 is a schematic configuration diagram showing a projector according to the present embodiment.

As shown in FIG. 1, a projector 1 according to the present embodiment is a projection-type image display device for displaying an image on a screen SCR. The projector 1 is provided with an illumination device 2, a color separation optical system 3, a light modulation device 4R, a light modulation device 4G, a light modulation device 4B, a combining optical system 5, and a projection optical device 6.

The illumination device 2 emits illumination light WL having a white color toward the color separation optical system 3. The configuration of the illumination device 2 will be described later in detail.

The color separation optical system 3 separates the illumination light WL having been emitted from the illumination device 2 into red light LR, green light LG, and blue light LB. The color separation optical system 3 is provided with a first dichroic mirror 7a, a second dichroic mirror 7b, a first total reflection mirror 8a, a second total reflection mirror 8b, a third total reflection mirror 8c, a first relay lens 9a, and a second relay lens 9b.

The first dichroic mirror 7a separates the illumination light WL from the illumination device 2 into the red light LR, and light including the green light LG and the blue light LB. The first dichroic mirror 7a transmits the red light LR, and at the same time, reflects the light including the green light LG and the blue light LB. Meanwhile, the second dichroic mirror 7b reflects the green light LG, and at the same time, transmits the blue light LB. Thus, the second dichroic mirror 7b separates the light including the green light LG and the blue light LB into the green light LG and the blue light LB.

The first total reflection mirror 8a is disposed in the light path of the red light LR, and the red light LR which has been transmitted through the first dichroic mirror 7a is reflected by the first total reflection mirror 8a toward the light modulation device 4R. Meanwhile, the second total reflection mirror 8b and the third total reflection mirror 8c are arranged in the light path of the blue light LB, and the blue light LB which has been transmitted through the second dichroic mirror 7b is guided by the second total reflection mirror 8b and the third total reflection mirror 8c to the light modulation device 4B. The green light LG is reflected by the second dichroic mirror 7b toward the light modulation device 4G.

The first relay lens 9a is disposed between the second dichroic mirror 7b and the second total reflection mirror 8b in the light path of the blue light LB. The second relay lens 9b is disposed between the second total reflection mirror 8b and the third total reflection mirror 8c in the light path of the blue light LB. The first relay lens 9a and the second relay lens 9b compensate a light loss of the blue light LB caused by the fact that the optical path length of the blue light LB becomes longer than the optical path lengths of the red light LR and the green light LG.

The light modulation device 4R modulates the red light LR in accordance with image information to form image light corresponding to the red light LR. The light modulation device 4G modulates the green light LG in accordance with the image information to form image light corresponding to the green light LG. The light modulation device 4B modulates the blue light LB in accordance with the image information to form image light corresponding to the blue light LB.

In each of the light modulation device 4R, the light modulation device 4G, and the light modulation device 4B, there is used, for example, a transmissive liquid crystal panel. Further, in the incident side and the exit side of the liquid crystal panel, there are arranged polarization plates not shown, respectively.

At the incident side of the light modulation device 4R, a field lens 10R is disposed. The field lens 10R collimates red light LR entering the light modulation device 4R. At the incident side of the light modulation device 4G, a field lens 10G is disposed. The field lens 10G collimates the green light LG entering the light modulation device 4G. At the incident side of the light modulation device 4B, a field lens 10B is disposed. The field lens 10B collimates the blue light LB entering the light modulation device 4B.

The image light emitted from the light modulation device 4R, the image light emitted from the light modulation device 4G, and the image light emitted from the light modulation device 4B enter the combining optical system 5. The combining optical system 5 combines the image light corresponding to the red light LR, the image light corresponding to the green light LG, and the image light corresponding to the blue light LB with each other, and then emits the image light thus combined toward the projection optical device 6. In the combining optical system 5, there is used, for example, a cross dichroic prism.

The projection optical device 6 has a plurality of projection lenses. The projection optical device 6 projects the image light having been combined by the combining optical system 5 toward the screen SCR in an enlarged manner. Thus, an image thus enlarged is displayed on the screen SCR.

The configuration of the illumination device 2 will hereinafter be described.

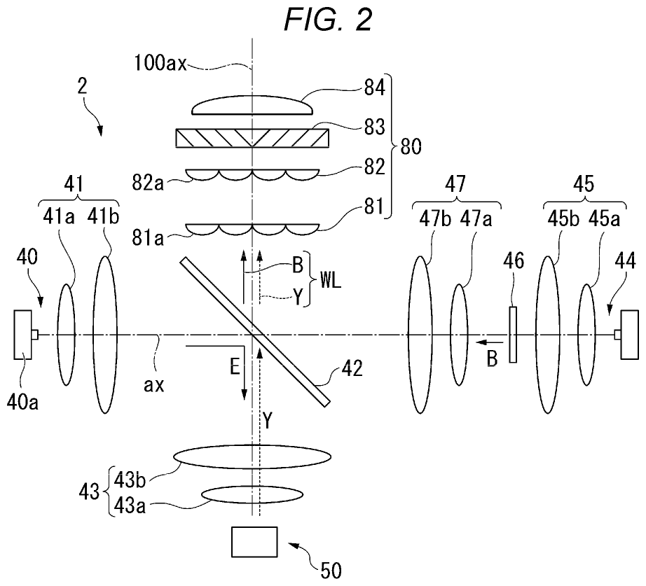

FIG. 2 is a schematic configuration diagram showing the illumination device 2 according to the present embodiment.

As shown in FIG. 2, the illumination device 2 is provided with a first light source 40, a collimating optical system 41, a dichroic mirror 42, a first light collection optical system 43, a wavelength conversion device 50, a second light source 44, a second light collection optical system 45, a diffuser plate 46, and a collimating optical system 47.

The first light source (a light source) 40 is formed of a plurality of semiconductor lasers 40a for emitting excitation light E having a blue color of a laser beam. A peak in light emission intensity of the excitation light E is at, for example, 445 nm. The plurality of semiconductor lasers 40a is disposed in an array in a single plane perpendicular to an optical axis ax of the first light source 40. It should be noted that as the semiconductor laser 40a, it is also possible to use a semiconductor laser for emitting blue light having a wavelength other than 445 nm such as 455 nm or 460 nm. The optical axis ax of the first light source 40 is perpendicular to an illumination light axis 100ax of the illumination device 2.

The collimating optical system 41 is provided with a first lens 41a and a second lens 41b. The collimating optical system 41 substantially collimates the light emitted from the first light source 40. The first lens 41a and the second lens 41b are each formed of a convex lens.

The dichroic mirror 42 is disposed in a light path from the collimating optical system 41 to the first light collection optical system 43 in a posture of crossing each of the optical axis ax of the first light source 40 and the illumination light axis 100ax at an angle of 45°. The dichroic mirror 42 reflects a blue light component, and transmits a red light component and a green light component. Therefore, the dichroic mirror 42 reflects the excitation light E and blue light B, and transmits fluorescence Y having a yellow color.

The first light collection optical system 43 makes the excitation light E having been transmitted through the dichroic mirror 42 converge to enter the wavelength conversion device 50, and at the same time, substantially collimates the fluorescence Y emitted from the wavelength conversion device 50. The first light collection optical system 43 is provided with a first lens 43a and a second lens 43b. The first lens 43a and the second lens 43b are each formed of a convex lens.

The second light source 44 is formed of a semiconductor laser having a wavelength band the same as the wavelength band of the first light source 40. The second light source 44 can be formed of single semiconductor laser, or can also be formed of a plurality of semiconductor lasers. Further, the second light source 44 can be formed of a semiconductor laser different in wavelength band from the semiconductor laser of the first light source 40.

The second light collection optical system 45 is provided with a first lens 45a and a second lens 45b. The blue light B emitted from the second light source 44 is converged by the second light collection optical system 45 on a diffusion surface or in the vicinity of the diffusion surface of the diffuser plate 46. The first lens 45a and the second lens 45b are each formed of a convex lens.

The diffuser plate 46 diffuses the blue light B emitted from the second light source 44 to thereby generate the blue light B having a light distribution similar to the light distribution of the fluorescence Y having been emitted from the wavelength conversion device 50. As the diffuser plate 46, there can be used obscured glass made of, for example, optical glass.

The collimating optical system 47 is provided with a first lens 47a and a second lens 47b. The collimating optical system 47 substantially collimates the light emitted from the diffuser plate 46. The first lens 47a and the second lens 47b are each formed of a convex lens.

The blue light B having been emitted from the second light source 44 is reflected by the dichroic mirror 42, and then combined with the fluorescence Y having been emitted from the wavelength conversion device 50 and then transmitted through the dichroic mirror 42 to thereby generate the illumination light WL having the white color. The illumination light WL enters a homogenous illumination optical system 80.

The homogenous illumination optical system 80 has a first lens array 81, a second lens array 82, a polarization conversion element 83, and a superimposing lens 84.

The first lens array 81 has a plurality of first lenses 81a for dividing the illumination light WL from the illumination device 2 into a plurality of partial light beams. The plurality of first lenses 81a is arranged in a matrix in a plane perpendicular to the illumination light axis 100ax.

The second lens array 82 has a plurality of second lenses 82a corresponding respectively to the plurality of first lenses 81a of the first lens array 81. The plurality of second lenses 82a is arranged in a matrix in a plane perpendicular to the illumination light axis 100ax.

The second lens array 82 forms an image of each of the first lenses 81a of the first lens array 81 in the vicinity of each of image forming areas of the light modulation device 4R, the light modulation device 4G, and the light modulation device 4B in cooperation with the superimposing lens 84.

The polarization conversion element 83 converts light emitted from the second lens array 82 into one type of linearly polarized light. The polarization conversion element 83 is provided with, for example, a polarization split film and a wave plate (both not shown).

The partial light beams emitted from the polarization conversion element 83 are converged by the superimposing lens 84 and are superimposed on each other in the vicinity of each of the image forming areas of the light modulation device 4R, the light modulation device 4G, and the light modulation device 4B.

Then, the configuration of the wavelength conversion device 50 will be described.

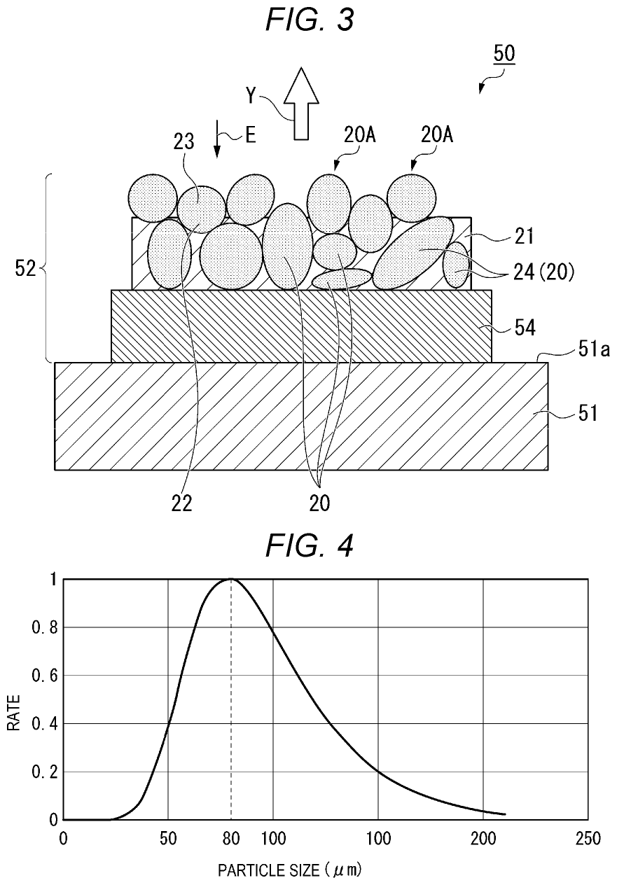

FIG. 3 is a cross-sectional view showing the configuration of the wavelength conversion device 50. FIG. 3 corresponds to a cross-sectional surface of the wavelength conversion device 50 cut along a plane including the illumination light axis 100ax shown in FIG. 2.

As shown in FIG. 3, the wavelength conversion device 50 is provided with a substrate 51, a wavelength conversion layer 52, and a reflecting layer 54. The wavelength conversion device 50 according to the present embodiment is formed of a stationary wavelength conversion device in which an incident position of the excitation light E to the wavelength conversion layer 52 does not temporally change.

The substrate 51 supports the wavelength conversion layer 52. The substrate 51 is formed of a flat substrate having high thermal conductivity made of, for example, aluminum, sapphire, or aluminum nitride. The wavelength conversion layer 52 performs the wavelength conversion on the excitation light E having entered the wavelength conversion layer 52 from one side thereof to obtain the fluorescence Y, and then emits the fluorescence Y from the same side, namely the one side thereof.

The reflecting layer 54 is disposed between the substrate 51 and the wavelength conversion layer 52. Specifically, the reflecting layer 54 is disposed on a surface 51a which is a support surface for the wavelength conversion layer 52 in the substrate 51. The reflecting layer 54 is formed of a metal film made of silver or the like having high optical reflectivity, a dielectric multilayer film, or a combination of these films. The fluorescence Y having proceeded toward an opposite side (the substrate 51 side) to the light incident side in the inside of the wavelength conversion layer 52 is reflected by the reflecting layer 54 toward the light incident side. It should be noted that it is possible for the reflecting layer 54 to reflect a part of the excitation light E toward the light incident side, and the excitation light E having been reflected by the reflecting layer 54 is used for the excitation of the fluorescence Y.

Based on such a configuration, the wavelength conversion device 50 according to the present embodiment is disposed to function as a reflective wavelength conversion device for emitting the fluorescence Y from the light incident side of the wavelength conversion layer 52 which the excitation light E enters.

The wavelength conversion layer 52 includes a plurality of phosphor particles 20 and a bonding member 21. The plurality of phosphor particles 20 performs the wavelength conversion on the excitation light E to thereby generate the fluorescence Y.

The plurality of phosphor particles 20 is formed of, for example, yttrium aluminum garnet added with cerium (Ce) (YAG (Y₃Al₅O₁₂):Ce) as an activator agent. Each of the phosphor particles 20 is formed by bonding crystalline body such as Y₂O₃, Al₂O₃, or CeO₃ with resin, calcining the result at a temperature no lower than 1600° C. after pressing the result, and then crushing the sintered body with, for example, a roll crusher, a hammer, or a cutter. Alternatively, it is possible to use YAG particles large in particle size which are formed from a YAG raw material using a gas-phase process such as a spray drying process, a flame heat decomposition process, or a thermal plasma process.

In the wavelength conversion layer 52 in the present embodiment, some of the phosphor particles 20 are thermally coupled to the reflecting layer 54. Those thermally coupled to the reflecting layer 54 out of the plurality of phosphor particles 20 in FIG. 3 are referred to as phosphor particles 24.

Here, the phosphor particles 24 thermally coupled to the reflecting layer 54 include not only the state in which the phosphor particles 24 and the reflecting layer 54 have direct contact with each other, but also the state in which a gap of 1 through 2 μm so small as to keep the thermal conductivity intervenes therebetween. It should be noted that in the case of the present embodiment, the bonding member 21 is disposed in the gap between the phosphor particles 24 and the reflecting layer 54.

According to this configuration, since the heat of the phosphor particles 24 transfers from the reflecting layer 54 to the substrate 51 to be released, it is possible to enhance the radiation performance of the wavelength conversion layer 52.

Further, in the wavelength conversion layer 52 in the present embodiment, 50% or more of the phosphor particles 20 are thermally coupled to each other. In other words, a half or more of the phosphor particles 20 have contact with adjacent one of the phosphor particles 20, or are arranged via the gap capable of conducting heat with adjacent one of the phosphor particles 20. According to this configuration, since the heat efficiently transfers between the phosphor particles 20, it is possible to enhance the radiation performance of the wavelength conversion layer 52.

Further, in the wavelength conversion layer 52 related to the present embodiment, some of the phosphor particles 20 are exposed from the bonding member 21 at an opposite side to the substrate 51, namely the light incident side, of the wavelength conversion layer 52. In the wavelength conversion layer 52 related to the present embodiment, some of uppermost layer phosphor particles 20A closest to the plane of incidence of light out of the plurality of phosphor particles 20 are exposed from the bonding member 21.

The uppermost layer phosphor particles 20A each have a base portion 22 at an opposite side to the light incident side, and a tip portion 23 located at the light incident side. In each of the uppermost layer phosphor particles 20A, the base portion 22 is only partially covered with the bonding member 21, and the tip portion 23 is exposed from the bonding member 21 to have contact with an air layer around the uppermost layer phosphor particles 20A.

In the wavelength conversion layer 52 related to the present embodiment, the particles on a surface at the opposite side to the substrate 51, namely the uppermost layer phosphor particles 20A located on the plane of incidence of light, are bonded to other phosphor particles 20 via the bonding member 21, but no phosphor particle which is not bonded to the bonding member 21 exists around the uppermost layer phosphor particles 20A. This is because the uppermost layer phosphor particles 20A can be obtained by removing surplus particles which are not bonded to the bonding member 21 and are in a floating state, from the plurality of phosphor particles 20 exposed from the bonding member 21 by a manufacturing process described later.

In other words, in the wavelength conversion layer 52 related to the present embodiment, the phosphor particle which fails to be bonded to other phosphor particles 20 via the bonding member 21 is removed on the surface at the opposite side to the substrate 51, namely the plane of incidence of light. It should be noted that in the wavelength conversion device 50 related to the present embodiment, a single layer antireflection coat formed of, for example, magnesium fluoride not shown is disposed on the surface at the opposite side to the substrate 51 of the wavelength conversion layer 52. In other words, the antireflection coat is disposed on the tip portion 23 of each of the uppermost layer phosphor particles 20A which are exposed from the bonding member 21, and have contact with the air layer around the uppermost layer phosphor particles 20A. Thus, it is possible to prevent reflection of light caused by a refractive index difference in a boundary between the phosphor particles 20 and the air layer to increase the light intensity of the fluorescence Y emitted from the wavelength conversion layer 52.

In the wavelength conversion layer 52 related to the present embodiment, the plurality of phosphor particles 20 has a predetermined particle size distribution taking a variation in particle size into consideration.

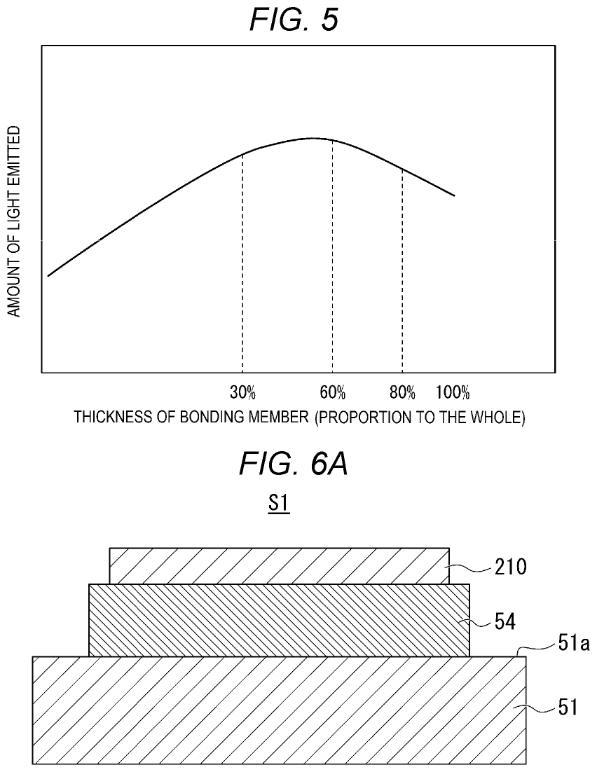

FIG. 4 is a graph representing a particle size distribution of the phosphor particles 20 in the present embodiment. In FIG. 4, the horizontal axis represents the particle size, and the vertical axis represents a rate.

As shown in FIG. 4, the particle size distribution of the phosphor particles 20 related to the present embodiment has a distribution in which the particle size gently varies from 40 μm to 200 μm. In other words, the particle size distribution of the plurality of phosphor particles 20 in the present embodiment is no smaller than 40 μm and no larger than 200 μm.

Further, the center value of the particle size distribution of the plurality of phosphor particles 20 is made no smaller than 70 μm and no larger than 150 μm. It should be noted that the center value of the particle size distribution means the particle size of the particles the largest in number out of the particle size distribution of the plurality of phosphor particles 20. The center value of the particle size distribution is preferably made no smaller than 70 μm and no larger than 120 μm, and is more preferably made no smaller than 70 μm and no larger than 100 μm. In the case of the present embodiment, the center value of the particle size distribution is 80 μm.

The particle size distribution of the plurality of phosphor particles 20 is defined by 95% or more of all of the phosphor particles 20 included in the wavelength conversion layer 52. This is because it is extremely difficult to control the particle size of all of the phosphor particles 20 included in the wavelength conversion layer 52. Specifically, although the phosphor particles 20 in the present embodiment include small-particle size particles such as particles having the particle size of 30 μm, the small-particle size particles are lower in proportion than 5%, and are low in influence.

The particle size of the plurality of phosphor particles 20 is preferably made no smaller than 40 μm and no larger than 150 μm, and is more preferably made no smaller than 40 μm and no larger than 100 μm.

The bonding member 21 bonds the phosphor particles 20 to each other, and the plurality of phosphor particles 20 and the substrate 51 to each other.

As the bonding member 21, there is used, for example, silicone resin, or an inorganic adhesive such as a silazane compound or low-melting point glass. The silazane compound is extremely small in color change with respect to the excitation light E, and is excellent in reliability. Further, since the thermal conductivity of the silazane compound is 1.4 W/K·m 10 times as high as the thermal conductivity of the silicone resin, the silazane compound that is more preferable in it becomes possible to efficiently transfer the heat of the phosphor particles 20 toward the substrate 51.

The thickness in the wavelength conversion layer 52 is set so as to include one through three phosphor particles 20 in the thickness direction. Therefore, the thickness in the wavelength conversion layer 52 becomes no smaller than the minimum particle size 40 μm of the phosphor particles 20, and no larger than the maximum particle size 200 μm of the phosphor particles 20. Specifically, the thickness in the wavelength conversion 52 is preferably set no smaller than 60 μm and no larger than 150 μm, and the preferable thickness is no smaller than 60 μm and no larger than 100 μm, and the thickness no smaller than 70 μm and no larger than 90 μm is more preferable. It should be noted that it results in that the phosphor particles 20 larger in particle size than the thickness of the wavelength conversion layer 52 are arranged in an oblique direction in the thickness direction of the wavelength conversion layer 52.

The surface of the wavelength conversion layer 52 has a shape including asperity due to the plurality of phosphor particles 20. For example, when viewed locally, the thickness of the wavelength conversion layer 52 locally becomes 40 μm in a region including the phosphor particles 20 having the minimum particle size of 40 μm, and locally becomes 200 μm in some cases in a region including the phosphor particles 20 having the maximum particle size of 200 μm.

Therefore, it is determined in the present specification that the thickness of the wavelength conversion layer 52 is defined using an average value including the asperity due to the plurality of phosphor particles 20. In the wavelength conversion layer 52 related to the present embodiment, for example, the thickness is set to 80 μm.

The inventors have obtained the knowledge that the thickness of the bonding member 21 affects an amount of fluorescence Y emitted.

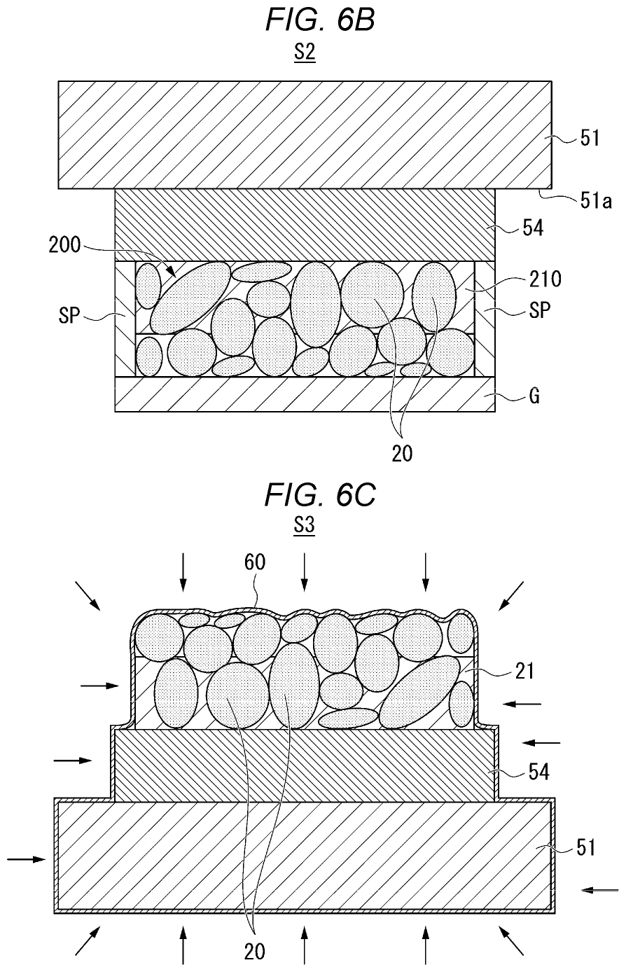

FIG. 5 is a graph representing a relationship between the thickness of the bonding member and an amount of fluorescence emitted. In the graph shown in FIG. 5, the horizontal axis corresponds to a proportion of the thickness of the bonding member to the whole of the wavelength conversion layer, and the vertical axis corresponds to the amount of fluorescence emitted.

As shown in FIG. 5, it is understood that when the thickness of the bonding member 21 is smaller than 30% of the thickness of the wavelength conversion layer 52, the amount of the fluorescence Y emitted decreases. This is because, the number of the phosphor particles 20 decreases since it becomes unachievable to stably bond the plurality of phosphor particles 20 to the substrate 51 since the thickness of the bonding member 21 becomes excessively small.

Normally, the amount of fluorescence emitted gradually increases as the thickness of the wavelength conversion layer 52 increases together with the thickness of the bonding member 21, but when the thickness of the bonding member 21 exceeds 60% of the thickness of the wavelength conversion layer 52, an amount of fluorescence extracted gradually decreases. This is because, the proportion of the fluorescence Y to be confined inside the bonding member 21 to the fluorescence Y emitted increases, and thus, the fluorescence Y becomes difficult to be emitted to the outside.

In the wavelength conversion layer 52 related to the present embodiment, the thickness of the bonding member 21 is set no lower than 30% and no higher than 80% of the thickness of the wavelength conversion layer 52 based on the graph shown in FIG. 5. It is more preferable for the thickness of the bonding member 21 to be set no lower than 40% and no higher than 60% of the thickness of the wavelength conversion layer 52.

In the wavelength conversion layer 52 related to the present embodiment, the thickness of the bonding member 21 is set to 40 μm when the thickness of the wavelength conversion layer 52 is set to 80 μm.

Then, a preferable range of the thickness of the wavelength conversion layer 52 will be described based on an analogy with a measurement experimentation of the ceramics phosphor with no gas cavity.

An amount of absorption of the excitation light by a TAG: Ce phosphor, namely an amount of fluorescence emitted, is proportional to EXP(−λ×t). The coefficient A represents a degree of absorption, and the character t represents a distance. According to the present experimentation, when setting the Ce concentration in the ceramics phosphor to 0.3% through 1%, an amount of the Ce ion is insufficient with the thickness of the ceramics phosphor no larger than 30 μm, and therefore, it is unachievable to sufficiently convert the excitation light into the fluorescence.

Further, when the thickness of the ceramics phosphor is no smaller than 60 μm, since spread of the fluorescence inside the phosphor widens, an uptake efficiency of the light in an optical system in the posterior stage drops, and thus, the light use efficiency of the fluorescence decreases. Therefore, in the case of the ceramics phosphor which is nearly 100% in filling rate with the phosphor, by setting the thickness of the phosphor to 30 μm through 60 μm, it becomes possible to increase the fluorescence conversion efficiency and at the same time, increase the use efficiency of the fluorescence.

In the wavelength conversion layer 52 related to the present embodiment, the filling rate with the phosphor particles 20 is set to a relatively low value of no lower than 40% and no higher than 50%, or more preferably no lower than 40% and lower than 50%. The reason for that is that a minute gap becomes easy to occur between the phosphor particles 20 since the particle having a small particle size no larger than 30 μm is hardly included since the particle size distribution of the phosphor particles 20 is set no smaller than 40 μm and no larger than 200 μm as described later.

The wavelength conversion layer 52 related to the present embodiment is disposed to increase the phosphor conversion efficiency, and at the same time, increase the use efficiency of the fluorescence by setting the thickness thereof in a range from 60 μm (=30 μm/0.5) to 150 μm (=60 μm/0.4), namely no smaller than 60 μm and no larger than 150 μm.

Then, the grounds for the range of the particle size distribution of the phosphor particles 20 will be described.

In general, in the projector, by making the product of the flux passing through the liquid crystal panel and the panel area, and the product of the flux emitted in the phosphor layer and the emission area of the phosphor layer the same as each other, it becomes possible to minimize an energy loss.

For example, when setting the diagonal size of the liquid crystal panel to 25 mm, the panel area becomes about 20 mm². Further, assuming the projection lens as F2, an uptake solid angle becomes 2×π×(1-cos(14°)). It should be noted that a spread angle of F2 is defined as arctan (0.5/2)=14°.

Meanwhile, defining the emission area of the phosphor layer as S, the solid angle of the fluorescence emitted becomes 2×π×(1-cos(70°)). Here, when taking the fluorescence emitted from the phosphor layer with a pickup lens, since an amount of reflection by the surface of the pickup lens increases and the uptake efficiency decreases when the emission angle of the fluorescence exceeds 70 degrees, the uptake angle of the pickup lens is set to 70° in the formula described above.

Therefore, when setting the emission area S so that the product of the area and the solid angle becomes equal between the panel side and the phosphor layer side, S=3.2 mm² is obtained. The phosphor layer having such an emission area S corresponds to 1.8 mm×1.8 mm.

Here, when the wavelength conversion layer includes the plurality of phosphor particles, there occurs blur in which the emission region of the fluorescence becomes larger as much as about a single phosphor particle than the irradiation area with the excitation light. As such blur of the fluorescence increases, it is unachievable for the optical system in the posterior stage to take the fluorescence emitted from the phosphor layer, and the light use efficiency of the fluorescence decrease to cause the light loss.

For example, when the blur region generated in the phosphor layer 1.8 mm on a side is suppressed to a size no larger than 10% in left, right, upper, and lower directions, it becomes possible to suppress the light loss described above to no higher than 30%.

In other words, it results in that it is sufficient to make the particle size of the phosphor particles no larger than 180 μm (=1.8 mm×10%) in order to suppress the light loss due to the blur of the fluorescence generated in the phosphor layer 1.8 mm on a side to no higher than 30%. Further, it is possible to suppress the light loss to no higher than 25% when setting the particle size of the phosphor particles to 150 μm, and it is possible to suppress the light loss to no higher than 22% when setting the particle size of the phosphor particles to no larger than 120 μm.

In reality, since the light intensity of the blur component of the fluorescence is low, by setting the maximum particle size of the phosphor particles to 180 μm, it is possible to sufficiently decrease the light loss. In contrast, when the particle size of the phosphor particles 20 becomes larger than 200 μm, it becomes difficult to control the thickness of the wavelength conversion layer 52 to no larger than 150 μm.

Based on such a consideration, in the wavelength conversion layer 52 related to the present embodiment, an upper limit of the particle size distribution of the phosphor particles 20 is set to 200 μm.

This is because, when the particle size of the phosphor particles becomes smaller than 40 μm on the other hand, since the specific surface area increases, reflection of the fluorescence by the phosphor particles increases, and the amount of fluorescence which can be extracted from the surface of the wavelength conversion layer decreases. Further, in order to fix the phosphor particles small in particle size, there arises necessity of increasing the thickness of a binder layer up to the whole of the wavelength conversion layer. This is because, since the binder layer is higher in refractive index than the air layer, when an embedded amount in the binder layer in the phosphor particles increases, reflection of the fluorescence on the interface between the binder layer and the phosphor particles occurs, and the fluorescence is absorbed by the phosphor particles, and thus, an extraction efficiency of the fluorescence decreases.

Therefore, when the particle size of the phosphor particles decreases, the extraction efficiency of the fluorescence decreases, and it is necessary for the heat generated in the wavelength conversion layer by the fluorescence emission to pass through the interfaces between a number of phosphor particles small in particle size and the binder layer before reaching the substrate, and since the thermal resistance of the wavelength conversion layer increases, the amount of the fluorescence emitted decreases.

Based on such a consideration, in the wavelength conversion layer 52 related to the present embodiment, a lower limit of the particle size distribution of the phosphor particles 20 is set to 40 μm. As described above, it is difficult to control the particle size of all of the phosphor particles 20, and some particles smaller in particle size than the lower limit value of 40 μm are also included, but by setting the lower limit value, it is possible to decrease the influence of the particles smaller in particle size than 40 μm to a negligible level.

For example, the specific surface area of the 30-μm phosphor particle becomes 1.3 times (=40/30) as large as the specific surface area of the 40-μm phosphor particle. When supposedly suppressing the proportion of the 40-μm phosphor particles to no lower than 6.5%, and suppressing the proportion of the 30-μm phosphor particles to no higher than 5%, it becomes possible to suppress the influence of the small particles no larger than 30 μm to a minimum.

As described above, in the wavelength conversion layer 52 related to the present embodiment, the lower limit of the particle size distribution of the phosphor particles 20 is set to 40 μm to thereby prevent the confinement by the reflection of the fluorescence due to the increase in specific surface area of the phosphor particles 20, and to suppress the thickness of the bonding member 21 corresponding to the binder layer to thereby increase the extraction efficiency of the fluorescence, and thus, it is possible to suppress the increase in thermal resistance due to an increase of the interfaces between the bonding member 21 and the phosphor particles 20.

In the wavelength conversion layer 52, as the distance from the plane of incidence of light increases, the absorption of the excitation light E in the phosphor particles 20 decreases in an exponential manner. Therefore, in the wavelength conversion layer 52, when the plurality of phosphor particles 20 is arranged in the thickness direction, there increases the absorption of the excitation light E in the phosphor particles 20 the closest to the plane of incidence of light side. In other words, in the wavelength conversion layer 52, there increases the light emission from the phosphor particles 20 located at the light incident extreme side.

Therefore, in the wavelength conversion layer 52, the uppermost layer phosphor particles 20A becomes the largest in absorption amount of the excitation light E out of the plurality of phosphor particles 20. The uppermost layer phosphor particles 20A each emit the fluorescence Y from the tip portion 23 thereof into the air layer. On the other hand, in the uppermost layer phosphor particles 20A, since the absorption amount of the excitation light E in the base portion 22 distant from the light incident side is smaller than that in the tip portion 23, and the contact area with the bonding member 21 is also small, an amount of fluorescence emitted from the base portion 22 into the bonding member 21 is small.

Further, the phosphor particles 20 located at the opposite side to the light incident side, namely the substrate 51 side, from the uppermost layer phosphor particles 20A are embedded in the bonding member 21, but the absorption of the excitation light E is smaller compared to the uppermost layer phosphor particles 20A, and therefore, the amount of fluorescence emitted is small, and as a result, an amount of the fluorescence emitted into the bonding member 21 decreases.

Further, since the amount of the fluorescence emitted into the bonding g member 21 decreases, the fluorescence Y confined in the bonding member 21 decreases, and therefore, it is possible to increase the extraction efficiency of the fluorescence Y as a result.

As described above, in the wavelength conversion layer 52 related to the present embodiment, by increasing the extraction efficiency of the fluorescence Y, it is possible to emit the bright fluorescence Y. Further, since the emission area decreases by suppressing the spread of the fluorescence to the inside of the bonding member 21, the etendue of the fluorescence Y also decreases. When the etendue of the fluorescence Y decreases in such a manner, it is possible to decrease the etendue of the illumination light WL including the fluorescence Y emitted from the wavelength conversion layer 52.

Therefore, it is possible for the illumination device 2 according to the present embodiment to increase the light use efficiency of the homogenous illumination optical system 80 which the illumination light WL enters.

Further, in the wavelength conversion layer 52 related to the present embodiment, the amount of fluorescence Y emitted increases, and thus, a large amount of heat is generated in the uppermost layer phosphor particles 20A.

In the wavelength conversion layer 52 related to the present embodiment, as described above, 50% or more of the plurality of phosphor particles 20 is thermally coupled to each other, and the phosphor particles 24 as some of the phosphor particles 20, are thermally coupled to the reflecting layer 54.

Therefore, the heat of the uppermost layer phosphor particles 20A transfers to the other of the phosphor particles 20 thermally coupled thereto, and then, the heat of the other of the phosphor particles 20 transfers to the reflecting layer 54 via the phosphor particles 24 thermally coupled thereto, and is then released from the substrate 51.

It should be noted that it is possible for any of the uppermost layer phosphor particles 20A to thermally be coupled to the reflecting layer 54. In this case, the heat of the uppermost layer phosphor particles 20A transfers to the reflecting layer 54 through the inside of the particles, and is then released from the substrate 51.

The wavelength conversion layer 52 related to the present embodiment is excellent in radiation performance, and therefore, it becomes possible to make the excitation light E high in luminance enter the wavelength conversion layer 52, and therefore, it is possible for the wavelength conversion layer 52 to efficiently extract the brighter fluorescence Y to the outside.

Then, a method of manufacturing the wavelength conversion device 50 according to the present embodiment will be described with reference to the drawings.

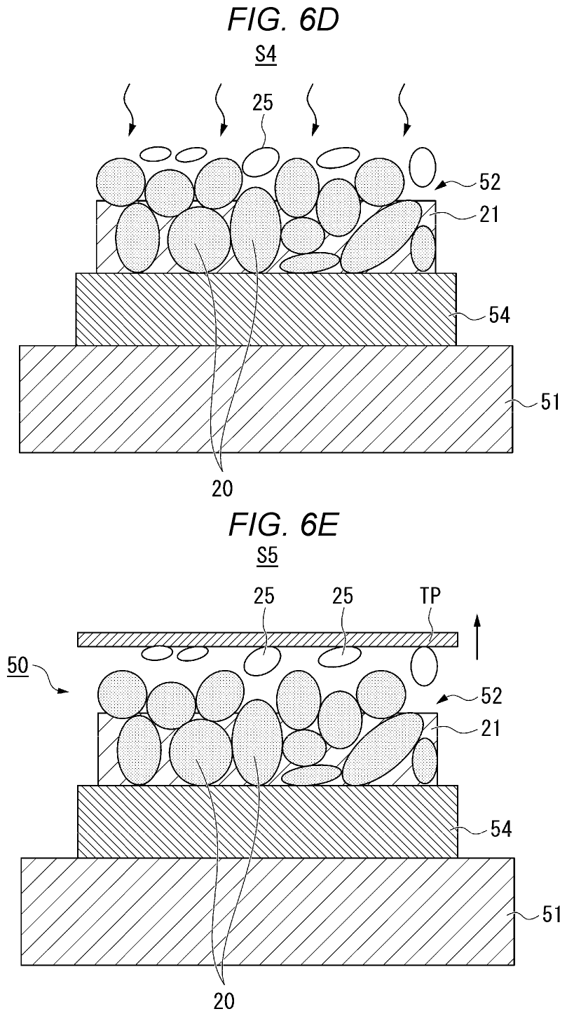

FIG. 6A through FIG. 6E are diagrams showing a manufacturing process of the wavelength conversion device 50.

First, as the first step S1, as shown in FIG. 6A, the substrate 51 having the reflecting layer 54 formed on the surface 51a is prepared, and then a coating film 210 for the bonding member formed of silicone for forming the bonding member 21 is applied on the reflecting layer 54 disposed on the substrate 51. The thickness of the coating film 210 for the bonding member is set to, for example, 20 μm.

Subsequently, as the second step S2, as shown in FIG. 6B, a phosphor particle group 200 is arranged inside a spacer member SP shaped like a frame arranged on a glass plate G. Specifically, the height of the spacer member SP is set so that the thickness of the phosphor particle group 200 becomes about 80 μm in accordance with the thickness of the wavelength conversion layer 52.

In the present embodiment, as the phosphor particle group 200, the particle group including the plurality of phosphor particles 20 having particle size no smaller than 40 μm and no larger than 200 μm is prepared in advance. It should be noted that, for example, a measuring instrument made by Microtrac, Inc. is used in the measurement of the particle size in the phosphor particles 20 when preparing the phosphor particle group 200.

Subsequently, the coating film 210 for the bonding member formed on the substrate 51 is inserted from above in the spacer member SP on the glass plate G, and then, the phosphor particle group 200 is arranged on the coating film 210 for the bonding member using a hand press.

It should be noted that as the pressing force of the hand press, there is set a range which can be achieved by a human hand, such as about 10 Kgf/cm².

After vertically flipping the substrate 51 and the glass plate G, and separating the glass plate G and the spacer member SP from the substrate 51, the phosphor particle group 200 is pressed by a pressing member 60 toward the reflecting layer 54 as the third step S3 as shown in FIG. 6C.

In the case of the present embodiment, the phosphor particle group 200 is pressed toward the reflecting layer 54 using a cold isotropic pressure (CIP) device. In the present embodiment, for example, fluid pressure is applied in a state of covering the substrate 51, the phosphor particle group 200, and the coating film 210 for the bonding member with a forming mold low in deformation resistance such as rubber as the pressing member 60 to compress the plurality of phosphor particles 20 included in the phosphor particle group 200 by evenly applying high pressure to thereby adjust the filling rate with the phosphor particles 20 to no lower than 30% and no higher than 55%, or more preferably to no lower than 40% and lower than 50%.

In the case of the present embodiment, for example, in the cold isotropic pressure device, by applying the pressure of about 5 MPa, 50% or more of the plurality of phosphor particles 20 gets to the state in which the phosphor particles have contact with each other, or the state in which a gap of about 1 through 2 μm in the extent that the thermal conduction can be achieved is disposed between the phosphor particles, namely the state in which the phosphor particles are thermally coupled to each other. It should be noted that by applying higher pressure such as the pressure no lower than 10 MPa and no higher than 50 MPa, it is possible to further more enhance the thermal coupling of the phosphor particles 20.

Further, the phosphor particles 20 located at the substrate 51 side out of the plurality of phosphor particles 20 get into the state in which the phosphor particles have contact with the reflecting layer 54 disposed on the substrate 51, or the state in which a gap with which the thermal conduction can be achieved is disposed between the phosphor particles and the reflecting layer 54, namely the state in which the phosphor particles and the substrate 51 are thermally coupled to each other.

In such a manner, the coating film 210 for the bonding member gets into a space between the phosphor particles 20 included in the phosphor particle group 200 without a gap. It should be noted that the thickness of the coating film 210 for the bonding member after the pressurization is determined by the filling rate with the phosphor particles 20. This is because, when the filling rate is too low, a desired emission characteristic cannot be obtained, and when the filling rate is too high, the content of the phosphor particles 20 small in particle size increases to thereby decrease the emission efficiency.

In the case of the present embodiment, as described above, the filling rate with the phosphor particles 20 is set no lower than 30% and no higher than 55%, and more preferably set no lower than 40% and lower than 50%. Thus, the thickness of the coating film 210 for the bonding member is set to 40 μm twice as large as the thickness in the state of being applied first to the glass plate G.

Subsequently, as the fourth step S4, as shown in FIG. 6D, the coating film 210 for the bonding member is calcined at 150° C. for a predetermined time together with the substrate 51 and the phosphor particle group 200 to form the bonding member 21. In such a manner, it is possible to form the wavelength conversion layer 52 in which the plurality of phosphor particles 20 is bonded to the reflecting layer 54 on the substrate 51 via the bonding member 21.

Here, some of the phosphor particles included in the phosphor particle group 200 are not bonded, or are hardly bonded to the bonding member 21. Specifically, on the upper surface of the wavelength conversion layer 52, there remain surplus particles 25 which are not bonded to the bonding member 21 and are in a floating state. Such surplus particles 25 has a possibility of being easily separated to turn to a foreign matter in the illumination device 2, or a possibility of retaining the heat generated when generating the fluorescence.

In the present embodiment, as the fifth step S5, as shown in FIG. 6E, the surplus particles 25 which are not bonded to the other of the phosphor particles 20 via the bonding member 21 out of the phosphor particle group 200 are removed on the surface of the wavelength conversion layer 52 at the opposite side to the substrate 51 using an adhesive tape TP. Subsequently, the antireflection coat not shown described above is formed on the upper surface of the wavelength conversion layer 52 using a vacuum evaporation system. The wavelength conversion device 50 according to the present embodiment is manufactured in such a manner as described above.

According to the wavelength conversion device 50 related to the present embodiment, there are provided the substrate 51, the wavelength conversion layer 52 which is disposed on the substrate 51, and which includes the plurality of phosphor particles 20, and the bonding member 21 for coupling the plurality of phosphor particles 20 and the substrate 51 to each other, and the reflecting layer 54 which is arranged between the substrate 51 and the wavelength conversion layer 52, and which reflects the light emitted from the wavelength conversion layer 52. The particle size distribution of the plurality of phosphor particles 20 is no smaller than 40 μm and no larger than 200 μm. The center value of the particle size distribution is no smaller than 70 μm and no larger than 150 μm. The phosphor particles 24 as a part of the plurality of phosphor particles 20 are thermally coupled to the reflecting layer 54. 50% or more of the phosphor particles 20 are thermally coupled to each other. The thickness of the bonding member 21 is no smaller than 30% and no larger than 80% of the thickness of the wavelength conversion layer 52.

According to the wavelength conversion layer 52 related to the present embodiment, by increasing the extraction efficiency of the fluorescence Y, it is possible to emit the bright fluorescence Y. Further, by releasing the heat when emitting the fluorescence from the phosphor particles 24 to the substrate 51 via the reflecting layer 54, it is possible to enhance the radiation performance of the wavelength conversion layer 52. Therefore, since it is possible to make the excitation light E high in luminance enter the wavelength conversion layer 52, it is possible to efficiently extract brighter fluorescence Y to the outside.

According to the method of manufacturing the wavelength conversion device 50 related to the present embodiment which includes the substrate 51, the wavelength conversion layer 52 which is disposed on the substrate 51, and in which the plurality of phosphor particles 20 having the particle size no smaller than 40 μm and no larger than 200 μm, and the center value of the particle size distribution no smaller than 70 μm and no larger than 150 μm, and the substrate 51 are bonded to each other with the bonding member 21, and the reflecting layer 54 which is arranged between the substrate 51 and the wavelength conversion layer 52, and which reflects the light emitted from the wavelength conversion layer 52, and in which the thickness of the bonding member 21 is no smaller than 30% and no larger than 80% of the thickness of the wavelength conversion layer 52, there are included the first step S1 of applying the coating film 210 for the bonding member for forming the bonding member 21 on the reflecting layer 54 disposed on the substrate 51, the second step S2 of arranging the phosphor particle group 200 including the plurality of phosphor particles 20 in the coating film 210 for the bonding member, the third step S3 of pressing the phosphor particle group 200 toward the reflecting layer 54 with the pressing member 60, and the fourth step S4 of calcining the coating film 210 for the bonding member together with the substrate 51 and the phosphor particle group 200 to form the bonding member 21.

According to the method of manufacturing the wavelength conversion device 50 related to the present embodiment, it is possible to provide the wavelength conversion device 50 which increases the extraction efficiency of the fluorescence Y generated in the wavelength conversion layer 52 to thereby emit the bright fluorescence Y, and which releases the heat when emitting the fluorescence from the phosphor particles 20 to the substrate 51 via the reflecting layer 54 to thereby achieve the excellent radiation performance.

The illumination device 2 according to the present embodiment is provided with the first light source 40 for emitting the excitation light E, and the wavelength conversion device 50 which the excitation light E enters.

According to the illumination device 2 related to the present embodiment, it is possible to provide the illumination device for emitting the bright illumination light WL. Further, since the etendue of the fluorescence Y emitted from the wavelength conversion device 50 decreases, it is possible to provide the illumination device 2 in which the illumination light WL including the fluorescence Y is efficiently taken in the homogenous illumination optical system 80 to thereby increase the light use efficiency.

The projector 1 according to the present embodiment is provided with the illumination device 2, the light modulation devices 4R, 4G, and 4B for modulating the light emitted from the illumination device 2, and the projection optical device 6 for projecting the light modulated by the light modulation devices 4R, 4G, and 4B.

According to the projector 1 related to the present embodiment, it is possible to provide the projector which is excellent in display quality and is high in efficiency.

It should be noted that the scope of the present disclosure is not limited to the embodiment described above, and a variety of modifications can be provided thereto within the scope or the spirit of the present disclosure.

The specific descriptions of the shape, the number, the arrangement, the material, the manufacturing method, and so on of each of the components of the wavelength conversion device, the illumination device, and the projector described in the above embodiment are not limited to those of the embodiment described above, but can arbitrarily be modified.

Hereinafter, the conclusion of the present disclosure will supplementarily be noted.

### Supplementary Note 1

A wavelength conversion device including a substrate, a wavelength conversion layer which is disposed on the substrate, and which includes a plurality of phosphor particles and a bonding member configured to bond the plurality of phosphor particles and the substrate to each other, and a reflecting layer which is disposed between the substrate and the wavelength conversion layer, and which is configured to reflect light emitted from the wavelength conversion layer, wherein a particle size distribution of the plurality of phosphor particles is no smaller than 40 μm and no larger than 200 μm, a center value of the particle size distribution is no smaller than 70 μm and no larger than 150 μm, some of the phosphor particles are thermally coupled to the reflecting layer, 50% or more of the phosphor particles are thermally coupled to each other, and a thickness of the bonding member is no smaller than 30% and no larger than 80% of a thickness of the wavelength conversion layer.

According to the wavelength conversion device having this configuration, by increasing the extraction efficiency of the fluorescence generated by the wavelength conversion layer, it is possible to emit the bright fluorescence. Further, by releasing the heat when emitting the fluorescence from the phosphor particles to the substrate via the reflecting layer, it is possible to enhance the radiation performance of the wavelength conversion layer. Therefore, since it is possible to make the excitation light high in luminance enter the wavelength conversion layer, it is possible to efficiently extract the brighter fluorescence to the outside.

### Supplementary Note 2

The wavelength conversion device described in Supplementary Note 1, wherein some of the phosphor particles are exposed from the bonding member at an opposite side to the substrate of the wavelength conversion layer.

According to this configuration, by releasing the fluorescence from the phosphor particles exposed from the bonding member into the air layer, it is possible to reduce the amount of the fluorescence released into the bonding member. Thus, since the fluorescence is not confined in the bonding member, it is possible to increase the extraction efficiency of the fluorescence. Further, since the emission area of the fluorescence decreases by suppressing the spread of the fluorescence to the inside of the bonding member, it is possible to decrease the etendue of the fluorescence. Therefore, it is possible to make the fluorescence efficiently enter an optical system in the posterior stage.

### Supplementary Note 3

The wavelength conversion device described in one of Supplementary Note 1 and Supplementary Note 2, wherein a thickness of the wavelength conversion layer is no smaller than 60 μm and no larger than 150 μm.

According to this configuration, by combining the configuration with the phosphor particles having the particle size distribution described above with each other, it is possible to provide the wavelength conversion device which is excellent in radiation performance, and which generates the bright fluorescence.

### Supplementary Note 4

The wavelength conversion device described in any one of Supplementary Note 1 through Supplementary Note 3, wherein a phosphor particle which fails to be bonded to another phosphor particle via the bonding member is removed on a surface of the wavelength conversion layer at the opposite side to the substrate.

According to this configuration, since surplus particles which fail to be bonded to other phosphor particles are removed, it is possible to prevent an occurrence of a problem caused by the surplus particles such as an occurrence of the foreign matter and retention of the heat when generating the fluorescence.

### Supplementary Note 5

A method of manufacturing a wavelength conversion device which includes a substrate, a wavelength conversion layer which is disposed on the substrate, and in which a plurality of phosphor particles having a particle size no smaller than 40 μm and no larger than 200 μm, and a center value of a particle size distribution no smaller than 70 μm and no larger than 150 μm, and the substrate are bonded to each other with a bonding member, and a reflecting layer which is disposed between the substrate and the wavelength conversion layer, and which is configured to reflect light emitted from the wavelength conversion layer, wherein a thickness of the bonding member is no smaller than 30% and no larger than 80% of a thickness of the wavelength conversion layer, the method including a first step of applying a coating film for the bonding member configured to form the bonding member on the reflecting layer disposed on the substrate, a second step of arranging a phosphor particle group including the plurality of phosphor particles to the coating film for the bonding member, a third step of pressing the phosphor particle group toward the reflecting layer with a pressing member, and a fourth step of calcining the coating film for the bonding member together with the substrate and the phosphor particle group to form the bonding member.

According to the method of manufacturing the wavelength conversion device having this configuration, it is possible to provide the wavelength conversion device which increases the extraction efficiency of the fluorescence generated in the wavelength conversion layer to thereby emit the bright fluorescence, and which releases the heat when emitting the fluorescence from the phosphor particles to the substrate via the reflecting layer to thereby achieve the excellent radiation performance.

### Supplementary Note 6

The method of manufacturing the wavelength conversion device described in Supplementary Note 5, further including a fifth step of removing a surplus particle which is included in the phosphor particle group, and which fails to be bonded to another phosphor particle via the bonding member is removed on a surface of the wavelength conversion layer at an opposite side to the substrate.

According to this configuration, it is possible to remove the surplus particles which can be a cause of an occurrence of the foreign matter and retention of the heat when emitting the fluorescence. Thus, it is possible to prevent the occurrence of the problem such as the occurrence of the foreign matter and the degradation of the radiation performance.

### Supplementary Note 7

An illumination device including a light source configured to emit excitation light, and the wavelength conversion device which is described in any one of Supplementary Note 1 through Supplementary Note 4, and which the excitation light enters.

According to the illumination device having this configuration, it is possible to provide the illumination device for emitting the bright illumination light. Further, since the etendue of the fluorescence emitted from the wavelength conversion device decreases, it is possible to provide the illumination device in which the illumination light including the fluorescence is efficiently taken in an optical system in the posterior stage to thereby increase the light use efficiency.

### Supplementary Note 8

A projector including the illumination device described in Supplementary Note 7, a light modulation device configured to modulate light emitted from the illumination device, and a projection optical device configured to project the light modulated by the light modulation device.

According to the projector having this configuration, it is possible to provide the projector which is excellent in display quality and is high in efficiency.

What is claimed is:

1. A wavelength conversion device comprising:
a substrate;
a wavelength conversion layer disposed on the substrate and including a plurality of phosphor particles and a bonding member configured to bond the plurality of phosphor particles and the substrate to each other; and
a reflecting layer disposed between the substrate and the wavelength conversion layer and configured to reflect light emitted from the wavelength conversion layer, wherein
a particle size distribution of the plurality of phosphor particles is no smaller than 40 μm and no larger than 200 μm,
a center value of the particle size distribution is no smaller than 70 μm and no larger than 150 μm,
some of the phosphor particles are thermally coupled to the reflecting layer,
50% or more of the phosphor particles are thermally coupled to each other, and
a thickness of the bonding member is no smaller than 30% and no larger than 80% of a thickness of the wavelength conversion layer.

2. The wavelength conversion device according to claim 1, wherein
some of the phosphor particles are exposed from the bonding member at an opposite side to the substrate of the wavelength conversion layer.

3. The wavelength conversion device according to claim 1, wherein
the thickness of the wavelength conversion layer is no smaller than 60 μm and no larger than 150 μm.

4. The wavelength conversion device according to claim 1, wherein
a phosphor particle which fails to be bonded to another phosphor particle via the bonding member is removed on a surface of the wavelength conversion layer at the opposite side to the substrate.

5. A method of manufacturing a wavelength conversion device including
a substrate,
a wavelength conversion layer which is disposed on the substrate, and in which a plurality of phosphor particles and the substrate are bonded to each other with a bonding member, the phosphor particles having a particle size no smaller than 40 μm and no larger than 200 μm, and a center value of a particle size distribution no smaller than 70 μm and no larger than 150 μm, and
a reflecting layer disposed between the substrate and the wavelength conversion layer and configured to reflect light emitted from the wavelength conversion layer, wherein
a thickness of the bonding member is no smaller than 30% and no larger than 80% of a thickness of the wavelength conversion layer, the method comprising:
applying a coating film for the bonding member configured to form the bonding member on the reflecting layer disposed on the substrate;
arranging a phosphor particle group including the plurality of phosphor particles to the coating film for the bonding member;
pressing the phosphor particle group toward the reflecting layer with a pressing member; and
calcining the coating film for the bonding member together with the substrate and the phosphor particle group to form the bonding member.

6. The method of manufacturing the wavelength conversion device according to claim 5, further comprising:
removing a surplus particle which is included in the phosphor particle group, and which fails to be bonded to another phosphor particle via the bonding member on a surface of the wavelength conversion layer at an opposite side to the substrate.

7. An illumination device comprising:
a light source configured to emit excitation light; and
the wavelength conversion device according to claim 1 which the excitation light enters.

8. A projector comprising:
the illumination device according to claim 7;
a light modulation device configured to modulate light emitted from the illumination device; and
a projection optical device configured to project the light modulated by the light modulation device.
